(19) United States
(12) Patent Application Publication
(10) Pub. No.: US 2013/0141443 A1
(43) Pub. Date: Jun. 6, 2013

(54) SOFTWARE LIBRARIES FOR HETEROGENEOUS PARALLEL PROCESSING PLATFORMS

(71) Applicants: Michael L. Schmit, Cupertino, CA (US); Radha Giduthuri, Campbell, CA (US)

(72) Inventors: Michael L. Schmit, Cupertino, CA (US); Radha Giduthuri, Campbell, CA (US)

(21) Appl. No.: 13/309,203

(22) Filed: Dec. 1, 2011

(51) Int. Cl. G06F 15/80

(52) U.S. Cl. 345/505

(57) ABSTRACT

Systems, methods, and media for providing libraries within an OpenCL framework. Library source code is compiled into an intermediate representation and distributed to an end-user computing system. The computing system typically includes a CPU and one or more GPUs. The CPU compiles the intermediate representation of the library into an executable binary targeted to run on the GPUs. The CPU executes a host application, which invokes a kernel from the binary. The CPU retrieves the kernel from the binary and conveys the kernel to a GPU for execution.

### BACKGROUND

1. Field of the Invention

The present invention relates generally to computers and software, and in particular to abstracting software libraries for a variety of different parallel hardware platforms.

2. Description of the Related Art

Computers and other data processing devices typically have at least one control processor that is generally known as a central processing unit (CPU). Such computers and devices can also have other processors such as graphics processing units (GPUs) that are used for specialized processing of various types. For example, in a first set of applications, GPUs may be designed to perform graphics processing operations. GPUs generally comprise multiple processing elements that are capable of executing the same instruction on parallel data streams. In general, a CPU functions as the host and may hand-off specialized parallel tasks to other processors such as GPUs.

Several frameworks have been developed for heterogeneous computing platforms that have CPUs and GPUs. These frameworks include BrookGPU by Stanford University, CUDA by NVIDIA, and OpenCL™ by an industry consortium named Khronos Group. The OpenCL framework offers a C-like development environment in which users can create applications to run on various different types of CPUs, GPUs, digital signal processors (DSPs), and other processors. OpenCL also provides a compiler and a runtime environment in which code can be compiled and executed within a heterogeneous computing system. When using OpenCL, developers can use a single, unified toolchain and language to target all of the processors currently in use. This is done by presenting the developer with an abstract platform model that conceptualizes all of these architectures in a similar way, as well as an execution model supporting data and task parallelism across heterogeneous architectures.

OpenCL allows any application to tap into the vast GPU computing power included in many computing platforms that was previously available only to graphics applications. Using OpenCL it is possible to write programs which will run on any GPU for which the vendor has provided OpenCL drivers. When an OpenCL program is executed, a series of API calls configure the system for execution, an embedded Just In Time (JIT) compiler compiles the OpenCL code, and the runtime asynchronously coordinates execution between parallel kernels. Tasks may be offloaded from a host (e.g., CPU) to an accelerator device (e.g., GPU) in the same system.

A typical OpenCL-based system may take source code and run it through a JIT compiler to generate executable code for a target GPU. Then, the executable code, or portions of the executable code, are sent to the target GPU and are executed. However, this approach may take too long and it exposes the OpenCL source code. Therefore, there is a need in the art for OpenCL-based approaches for providing software libraries to an application within an OpenCL runtime environment without exposing the source code used to generate the libraries.

### SUMMARY OF EMBODIMENTS

In one embodiment, source code and source libraries may go through several compilation stages from a high-level software language to an instruction set architecture (ISA) binary containing kernels that are executable on specific target hardware. In one embodiment, the high-level software language of the source code and libraries may be Open Computing Language (OpenCL). Each source library may include a plurality of kernels that may be invoked from a software application executing on a CPU and may be conveyed to a GPU for actual execution.

The library source code may be compiled into an intermediate representation prior to being conveyed to an end-user computing system. In one embodiment, the intermediate representation may be a low level virtual machine (LLVM) intermediate representation. The intermediate representation may be provided to end-user computing systems as part of a software installation package. At install-time, the LLVM file may be compiled for the specific target hardware of the given end-user computing system. The CPU or other host device in the given computing system may compile the LLVM file to generate an ISA binary for the hardware target, such as a GPU, within the system.

At runtime, the ISA binary may be opened via a software development kit (SDK) which may check for proper installation and may retrieve one or more specific kernels from the ISA binary. The kernels may then be stored in memory and an application executing may deliver each kernel for execution to a GPU via the OpenCL runtime environment.

These and other features and advantages will become apparent to those of ordinary skill in the art in view of the following detailed descriptions of the approaches presented herein.

### BRIEF DESCRIPTION OF THE DRAWINGS

The above and further advantages of the methods and mechanisms may be better understood by referring to the following description in conjunction with the accompanying drawings, in which:

FIG. 1 is a block diagram of a computing system in accordance with one or more embodiments.

FIG. 2 is a block diagram of a distributed computing environment in accordance with one or more embodiments.

FIG. 3 is a block diagram of an OpenCL software environment in accordance with one or more embodiments.

FIG. 4 is a block diagram of an encrypted library in accordance with one or more embodiments.

FIG. 5 is a block diagram of one embodiment of a portion of another computing system.

FIG. 6 is a generalized flow diagram illustrating one embodiment of a method for providing a library within an OpenCL environment.

### DETAILED DESCRIPTION OF EMBODIMENTS

In the following description, numerous specific details are set forth to provide a thorough understanding of the methods and mechanisms presented herein. However, one having ordinary skill in the art should recognize that the various embodiments may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

This specification includes references to “one embodiment”. The appearance of the phrase “in one embodiment” in different contexts does not necessarily refer to the same embodiment. Particular features, structures, or characteristics may be combined in any suitable manner consistent with this disclosure. Furthermore, as used throughout this application, the word “may” is used in a permissive sense (i.e., meaning having the potential to), rather than the mandatory sense (i.e., meaning must). Similarly, the words “include”, “including”, and “includes” mean including, but not limited to.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A system comprising a host processor . . . .” Such a claim does not foreclose the system from including additional components (e.g., a network interface, a memory).

“Configured To.” Various units, circuits, or other components may be described or claimed as “configured to” perform a task or tasks. In such contexts, “configured to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical) unless explicitly defined as such. For example, in a system with four GPUs, the terms “first” and “second” GPUs can be used to refer to any two of the four GPUs.

“Based On.” As used herein, this term is used to describe one or more factors that affect a determination. This term does not foreclose additional factors that may affect a determination. That is, a determination may be based solely on those factors or based, at least in part, on those factors. Consider the phrase “determine A based on B.” While B may be a factor that affects the determination of A, such a phrase does not foreclose the determination of A from also being based on C. In other instances, A may be determined based solely on B.

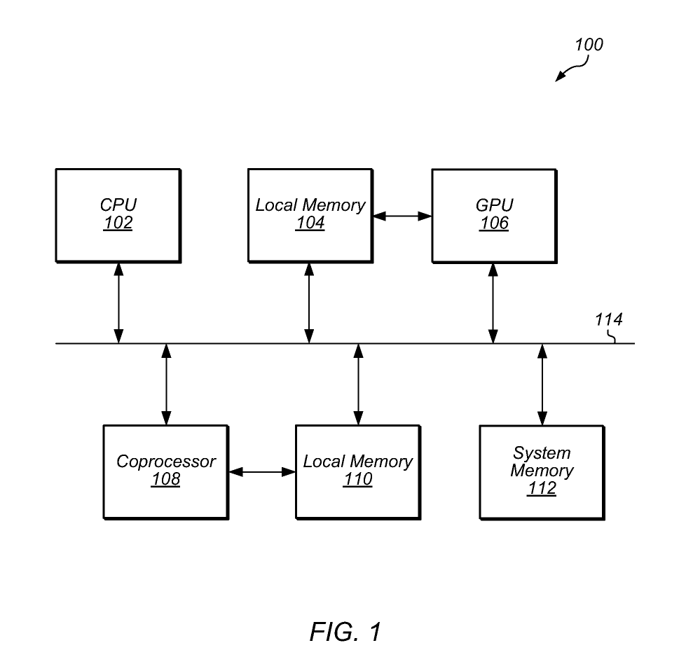

Referring now to FIG. 1, a block diagram of a computing system 100 according to one embodiment is shown. Computing system 100 includes a CPU 102, a GPU 106, and may optionally include a coprocessor 108. In the embodiment illustrated in FIG. 1, CPU 102 and GPU 106 are included on separate integrated circuits (ICs) or packages. In other embodiments, however, CPU 102 and GPU 106, or the collective functionality thereof, may be included in a single IC or package. In one embodiment, GPU 106 may have a parallel architecture that supports executing data-parallel applications.

In addition, computing system 100 also includes a system memory 112 that may be accessed by CPU 102, GPU 106, and coprocessor 108. In various embodiments, computing system 100 may comprise a supercomputer, a desktop computer, a laptop computer, a video-game console, an embedded device, a handheld device (e.g., a mobile telephone, smart phone, MP3 player, a camera, a GPS device, or the like), or some other device that includes or is configured to include a GPU. Although not specifically illustrated in FIG. 1, computing system 100 may also include a display device (e.g., cathode-ray tube, liquid crystal display, plasma display, etc.) for displaying content (e.g., graphics, video, etc.) of computing system 100.

GPU 106 assists CPU 102 by performing certain special functions (such as, graphics-processing tasks and data-parallel, general-compute tasks), usually faster than CPU 102 could perform them in software. Coprocessor 108 may also assist CPU 102 in performing various tasks. Coprocessor 108 may comprise, but is not limited to, a floating point coprocessor, a GPU, a video processing unit (VPU), a networking coprocessor, and other types of coprocessors and processors.

GPU 106 and coprocessor 108 may communicate with CPU 102 and system memory 112 over bus 114. Bus 114 may be any type of bus or communications fabric used in computer systems, including a peripheral component interface (PCI) bus, an accelerated graphics port (AGP) bus, a PCI Express (PCIE) bus, or another type of bus whether presently available or developed in the future.

In addition to system memory 112, computing system 100 further includes local memory 104 and local memory 110. Local memory 104 is coupled to GPU 106 and may also be coupled to bus 114. Local memory 110 is coupled to coprocessor 108 and may also be coupled to bus 114. Local memories 104 and 110 are available to GPU 106 and coprocessor 108, respectively, in order to provide faster access to certain data (such as data that is frequently used) than would be possible if the data were stored in system memory 112.

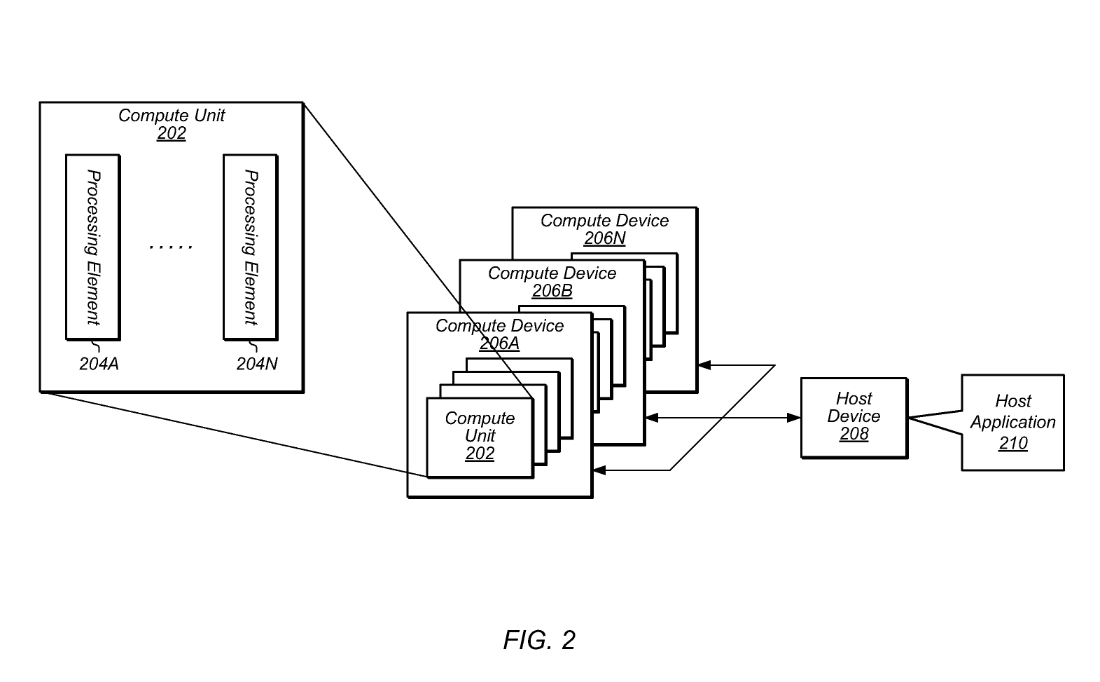

Turning now to FIG. 2, a block diagram illustrating one embodiment of a distributed computing environment is shown. Host application 210 may execute on host device 208, which may include one or more CPUs and/or other types of processors (e.g., systems on chips (SoCs), graphics processing units (GPUs), field programmable gate arrays (FPGAs), application-specific integrated circuits (ASICs)). Host device 208 may be coupled to each of compute devices 206A-N via various types of connections, including direct connections, bus connections, local area network (LAN) connections, internet connections, and the like. In addition, one or more of compute devices 206A-N may be part of a cloud computing environment.

Compute devices 206A-N are representative of any number of computing systems and processing devices which may be coupled to host device 208. Each compute device 206A-N may include a plurality of compute units 202. Each compute unit 202 may represent any of various types of processors, such as GPUs, CPUs, FPGAs, and the like. Additionally, each compute unit 202 may include a plurality of processing elements 204A-N.

Host application 210 may monitor and control other programs running on compute devices 206A-N. The programs running on compute devices 206A-N may include OpenCL kernels. In one embodiment, host application 210 may execute within an OpenCL runtime environment and may monitor the kernels executing on compute devices 206A-N. As used herein, the term “kernel” may refer to a function declared in a program that executes on a target device (e.g., GPU) within an OpenCL framework. The source code for the kernel may be written in the OpenCL language and compiled in one or more steps to create an executable form of the kernel. In one embodiment, the kernels to be executed by a compute unit 202 of compute device 206 may be broken up into a plurality of workloads, and workloads may be issued to different processing elements 204A-N in parallel. In other embodiments, other types of runtime environments other than OpenCL may be utilized by the distributed computing environment.

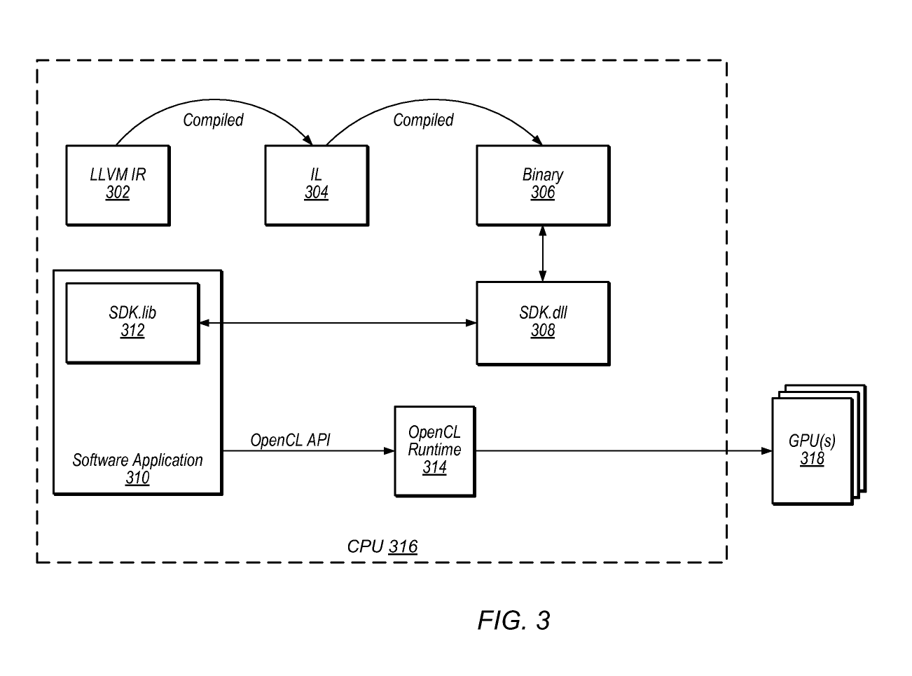

Referring now to FIG. 3, a block diagram illustrating one embodiment of an OpenCL software environment is shown. A software library specific to a certain type of processing (e.g., video editing, media processing, graphics processing) may be downloaded or included in an installation package for a computing system. The software library may be compiled from source code to a device-independent intermediate representation prior to being included in the installation package. In one embodiment, the intermediate representation (IR) may be a low-level virtual machine (LLVM) intermediate representation, such as LLVM IR 302. LLVM is an industry standard for a language-independent compiler framework, and LLVM defines a common, low-level code representation for the transformation of source code. In other embodiments, other types of IRs may be utilized. Distributing LLVM IR 302 instead of the source code may prevent unintended access or modification of the original source code.

LLVM IR 302 may be included in the installation package for various types of end-user computing systems. In one embodiment, at install-time, LLVM IR 302 may be compiled into an intermediate language (IL) 304. A compiler (not shown) may generate IL 304 from LLVM IR 302. IL 304 may include technical details that are specific to the target devices (e.g., GPUs 318), although IL 304 may not be executable on the target devices. In another embodiment, IL 304 may be provided as part of the installation package instead of LLVM IR 302.

Then, IL 304 may be compiled into the device-specific binary 306, which may be cached by CPU 316 or otherwise accessible for later use. The compiler used to generate binary 306 from IL 304 (and IL 304 from LLVM IR 302) may be provided to CPU 314 as part of a driver pack for GPUs 318. As used herein, the term “binary” may refer to a compiled, executable version of a library of kernels. Binary 306 may be targeted to a specific target device, and kernels may be retrieved from the binary and executed by the specific target device. The kernels from a binary compiled for a first target device may not be executable on a second target device. Binary 306 may also be referred to as an instruction set architecture (ISA) binary. In one embodiment, LLVM IR 302, IL 304, and binary 306 may be stored in a kernel database (KDB) file format. For example, file 302 may be marked as a LLVM IR version of a KDB file, file 304 may be an IL version of a KDB file, and file 306 may be a binary version of a KDB file.

The device specific binary 306 may include a plurality of executable kernels. The kernels may already be in a compiled, executable form such that they may be transferred to any of GPUs 318 and executed without having to go through a just-in-time (JIT) compile stage. When a specific kernel is accessed by software application 310, the specific kernel may be retrieved from and/or stored in memory. Therefore, for future accesses of the same kernel, the kernel may be retrieved from memory instead of being retrieved from binary 306. In another embodiment, the kernel may be stored in memory within GPUs 318 so that the kernel can be quickly accessed the next time the kernel is executed.

The software development kit (SDK) library (.lib) file, SDK.lib 312, may be utilized by software application 310 to provide access to binary 306 via dynamic-link library, SDK.dll 308. SDK.dll 308 may be utilized to access binary 306 from software application 310 at runtime, and SDK.dll 308 may be distributed to end-user computing systems along with LLVM IR 302. Software application 310 may utilize SDK.lib 312 to access binary 306 via SDK.dll 308 by making the appropriate API calls.

SDK.lib 312 may include a plurality of functions for accessing the kernels in binary 306. These functions may include an open function, get program function, and a close function. The open function may open binary 306 and load a master index table from binary 306 into memory within CPU 316. The get program function may select a single kernel from the master index table and copy the kernel from binary 306 into CPU 316 memory. The close function may release resources used by the open function.

In some embodiments, when the open function is called, software application 310 may determine if binary 306 has been compiled with the latest driver. If a new driver has been installed by CPU 316 and if binary 306 was compiled by a compiler from a previous driver, then the original LLVM IR 302 may be recompiled with the new compiler to create a new binary 306. In one embodiment, only the individual kernel that has been invoked may be recompiled. In another embodiment, the entire library of kernels may be recompiled. In a further embodiment, the recompilation may not occur at runtime. Instead, an installer may recognize all of the binaries stored in CPU 316, and when a new driver is installed, the installer may recompile LLVM IR 302 and any other LLVM IRs in the background when CPU 316 is not busy.

In one embodiment, CPU 316 may operate an OpenCL runtime environment. Software application 310 may include an OpenCL application-programming interface (API) for accessing the OpenCL runtime environment. In other embodiments, CPU 316 may operate other types of runtime environments. For example, in another embodiment, a DirectCompute runtime environment may be utilized.

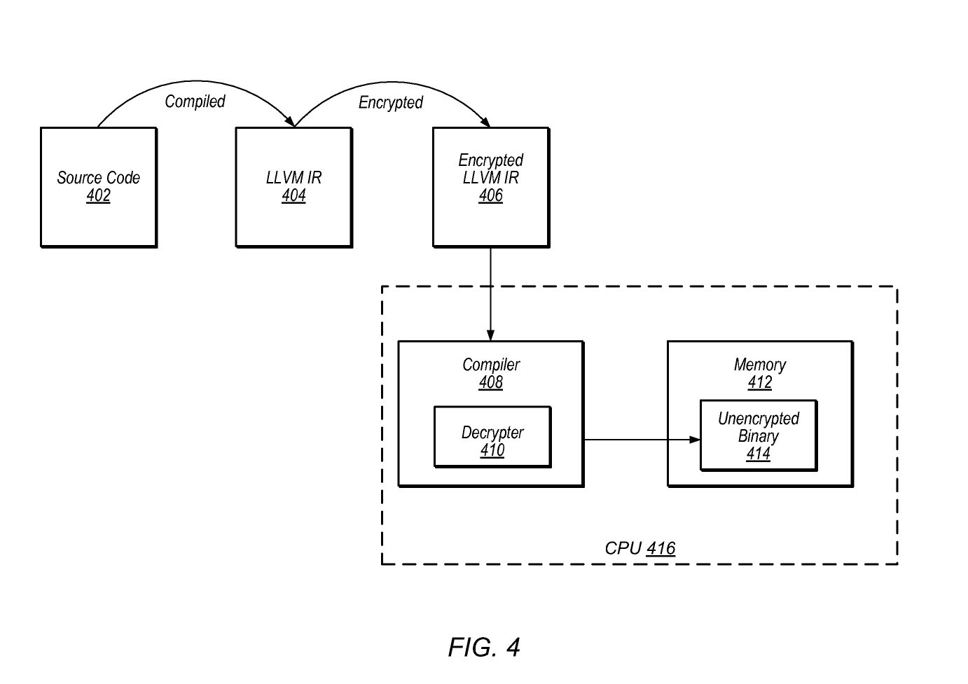

Turning now to FIG. 4, a block diagram of one embodiment of an encrypted library is shown. Source code 402 may be compiled to generate LLVM IR 404. LLVM IR 404 may be used to generate encrypted LLVM IR 406, which may be conveyed to CPU 416. Distributing encrypted LLVM IR 406 to end-users may provide extra protection of source code 402 and may prevent an unauthorized user from reverse-engineering LLVM IR 404 to generate an approximation of source code 402. Creating and distributing encrypted LLVM IR 406 may be an option that is available for certain libraries and certain installation packages. For example, the software developer of source code 402 may decide to use encryption to provide extra protection for their source code. In other embodiments, an IL version of source code 402 may be provided to end-users and in these embodiments, the IL file may be encrypted prior to being delivered to target computing systems.

When encryption is utilized, compiler 408 may include an embedded decrypter 410, which is configured to decrypt encrypted LLVM IR files. Compiler 408 may decrypt encrypted LLVM IR 406 and then perform the compilation to create unencrypted binary 414, which may be stored in memory 412. In another embodiment, unencrypted binary 414 may be stored in another memory (not shown) external to CPU 416. In some embodiments, compiler 408 may generate an IL representation (not shown) from LLVM IR 406 and then may generate unencrypted binary 414 from the IL. In various embodiments, a flag may be set in encrypted LLVM IR 406 to indicate that it is encrypted.

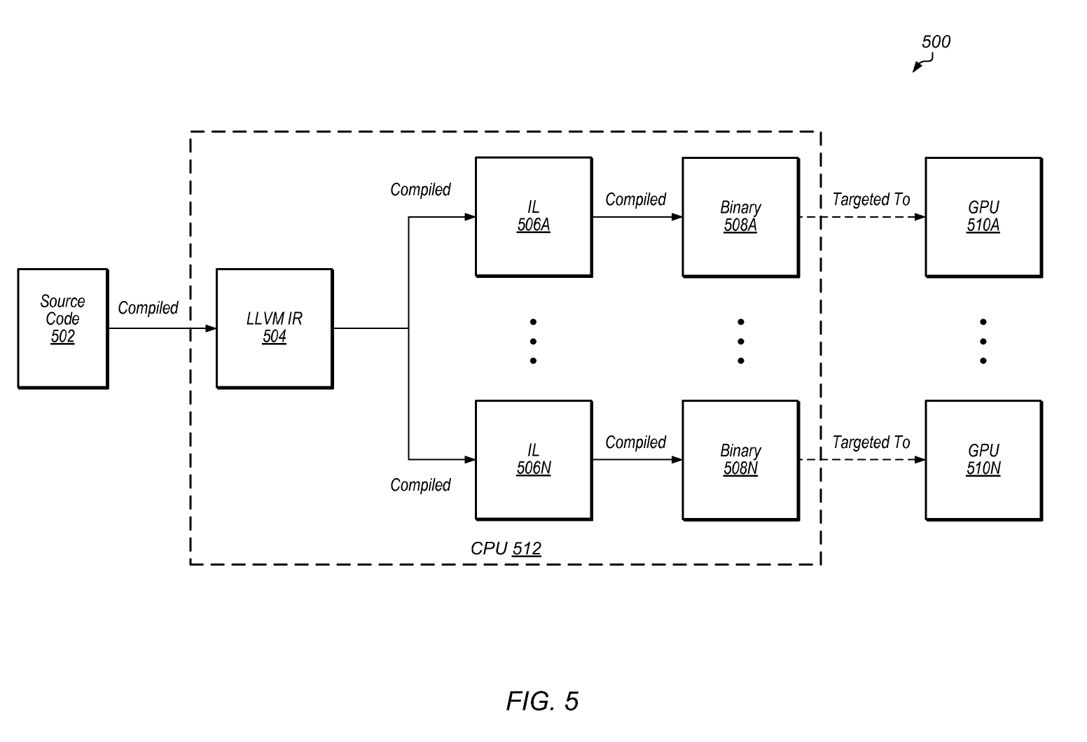

Referring now to FIG. 5, a block diagram of one embodiment of a portion of another computing system is shown. Source code 502 may represent any number of libraries and kernels which may be utilized by system 500. In one embodiment, source code 502 may be compiled into LLVM IR 504. LLVM IR 504 may be the same for GPUs 510A-N. In one embodiment, LLVM IR 504 may be compiled by separate compilers into intermediate language (IL) representations 506A-N. A first compiler (not shown) executing on CPU 512 may generate IL 506A and then IL 506A may be compiled into binary 508A. Binary 508A may be targeted to GPU 510A, which may have a first type of micro-architecture. Similarly, a second compiler (not shown) executing on CPU 512 may generate IL 506N and then IL 506N may be compiled into binary 508N. Binary 508N may be targeted to GPU 510N, which may have a second type of micro-architecture different than the first type of micro-architecture of GPU 510A.

Binaries 508A-N are representative of any number of binaries that may be generated and GPUs 510A-N are representative of any number of GPUs that may be included in the computing system 500. Binaries 508A-N may also include any number of kernels, and different kernels from source code 502 may be included within different binaries. For example, source code 502 may include a plurality of kernels. A first kernel may be intended for execution on GPU 510A, and so the first kernel may be compiled into binary 508A which targets GPU 510A. A second kernel from source code 502 may be intended for execution on GPU 510N, and so the second kernel may be compiled into binary 508N which targets GPU 510N. This process may be repeated such that any number of kernels may be included within binary 508A and any number of kernels may be included within binary 508N. Some kernels from source code 502 may be compiled and included into both binaries, some kernels may be compiled into only binary 508A, other kernels may be compiled into only binary 508N, and other kernels may not be included into either binary 508A or binary 508N. This process may be repeated for any number of binaries, and each binary may contain a subset or the entirety of kernels originating from source code 502. In other embodiments, other types of devices (e.g., FPGAs, ASICs) may be utilized within computing system 500 and may be targeted by one or more of binaries 508A-N.

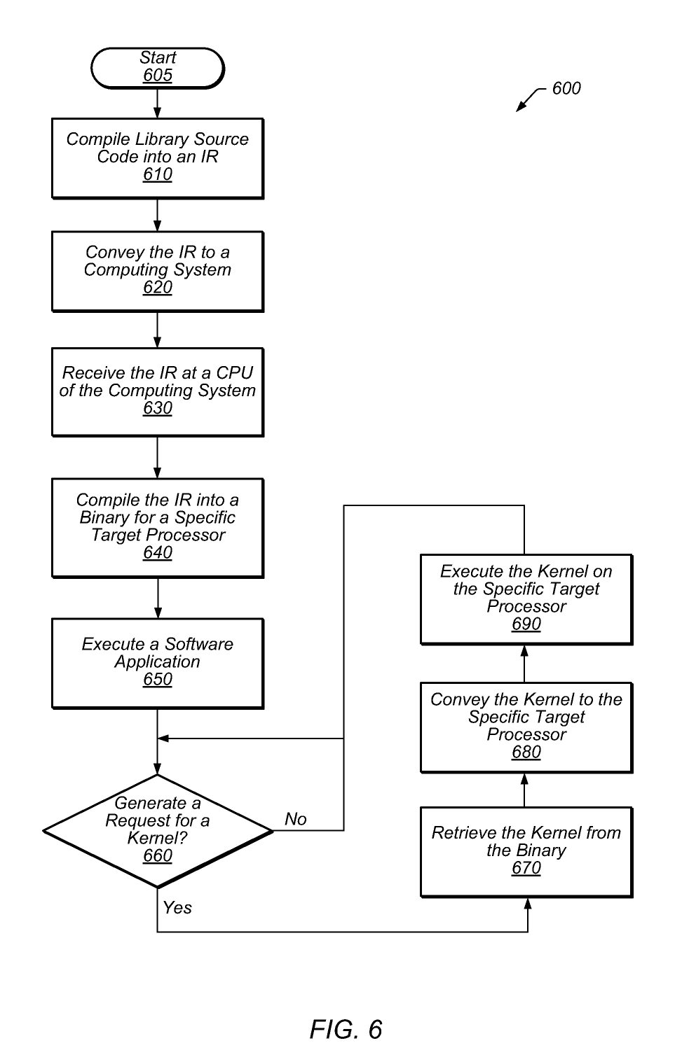

Turning now to FIG. 6, one embodiment of a method for providing a library within an OpenCL environment is shown. For purposes of discussion, the steps in this embodiment are shown in sequential order. It should be noted that in various embodiments of the method described below, one or more of the elements described may be performed concurrently, in a different order than shown, or may be omitted entirely. Other additional elements may also be performed as desired.

Method 600 may start in block 605, and then the source code of a library may be compiled into an intermediate representation (IR) (block 610). In one embodiment, the source code may be written in OpenCL. In other embodiments, the source code may be written in other languages (e.g., C, C++, Fortran). In one embodiment, the IR may be a LLVM intermediate representation. In other embodiments, other IRs may be utilized. Next, the IR may be conveyed to a computing system (block 620). The computing system may include a plurality of processors, including one or more CPUs and one or more GPUs. The computing system may download the IR, the IR may be part of an installation software package, or any of various other methods for conveying the IR to the computing system may be utilized.

After block 620, the IR may be received by a host processor of the computing system (block 630). In one embodiment, the host processor may be a CPU. In other embodiments, the host processor may be a digital signal processor (DSP), system on chip (SoC), microprocessor, GPU, or the like. Then, the IR may be compiled into a binary by a compiler executing on the CPU (block 640). The binary may be targeted to a specific target processor (e.g., GPU, FPGA) within the computing system. Alternatively, the binary may be targeted to a device or processor external to the computing system. The binary may include a plurality of kernels, wherein each of the kernels is directly executable on the specific target processor. In some embodiments, the kernels may be functions that take advantage of the parallel processing ability of a GPU or other device with a parallel architecture. The binary may be stored within CPU local memory, system memory, or in another storage location.

In one embodiment, the CPU may execute a software application (block 650), and the software application may interact with an OpenCL runtime environment to schedule specific tasks to be performed by one or more target processors. To perform these tasks, the software application may invoke calls to one or more functions corresponding to kernels from the binary. When the function call executes, a request for the kernel may be generated by the application (conditional block 660). Responsive to generating a request for a kernel, the application may invoke one or more API calls to retrieve the kernel from the binary (block 670).

If a request for a kernel is not generated (conditional block 660), then the software application may continue with its execution and may be ready to respond when a request to a kernel is generated. Then, after the kernel has been retrieved from the binary (block 670), the kernel may be conveyed to the specific target processor (block 680). The kernel may be conveyed to the specific target processor in a variety of manners, including as a string or in a buffer. Then, the kernel may be executed by the specific target processor (block 690). After block 690, the software application may continue to be executed on the CPU until another request for a kernel is generated (conditional block 660). Steps 610-640 may be repeated a plurality of times for a plurality of libraries that are utilized by the computing system. It is noted that while kernels are commonly executed on highly parallelized processors such as GPUs, kernels may also be executed on CPUs or on a combination of GPUs, CPUs, and other devices in a distributed manner.

It is noted that the above-described embodiments may comprise software. In such an embodiment, program instructions and/or a database that represent the described methods and mechanisms may be stored on a non-transitory computer readable storage medium. The program instructions may include machine readable instructions for execution by a machine, a processor, and/or any general purpose computer for use with or by any non-volatile memory device. Suitable processors include, by way of example, both general and special purpose processors.

Generally speaking, a non-transitory computer readable storage medium may include any storage media accessible by a computer during use to provide instructions and/or data to the computer. For example, a non-transitory computer readable storage medium may include storage media such as magnetic or optical media, e.g., disk (fixed or removable), tape, CD-ROM, DVD-ROM, CD-R, CD-RW, DVD-R, DVD-RW, or Blu-Ray. Storage media may further include volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM)), ROM, non-volatile memory (e.g., Flash memory) accessible via a peripheral interface such as the USB interface, etc. Storage media may include micro-electro-mechanical systems (MEMS), as well as storage media accessible via a communication medium such as a network and/or a wireless link.

In other embodiments, the program instructions that represent the described methods and mechanisms may be a behavioral-level description or register-transfer level (RTL) description of hardware functionality in a hardware design language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising the system. The netlist may then be placed and routed to produce a data set describing geometric shapes to be applied to masks. The masks may then be used in various semiconductor fabrication steps to produce a semiconductor circuit or circuits corresponding to the system. Alternatively, the database on the computer accessible storage medium may be the netlist (with or without the synthesis library) or the data set, as desired. While a computer accessible storage medium may carry a representation of a system, other embodiments may carry a representation of any portion of a system, as desired, including an IC, any set of programs (e.g., API, DLL, compiler) or portions of programs.

Types of hardware components, processors, or machines which may be used by or in conjunction with the present invention include ASICs, FPGAs, microprocessors, or any integrated circuit. Such processors may be manufactured by configuring a manufacturing process using the results of processed HDL instructions (such instructions capable of being stored on a computer readable medium). The results of such processing may be maskworks that are then used in a semiconductor manufacturing process to manufacture a processor which implements aspects of the methods and mechanisms described herein.

Although the features and elements are described in the example embodiments in particular combinations, each feature or element can be used alone without the other features and elements of the example embodiments or in various combinations with or without other features and elements. It should also be emphasized that the above-described embodiments are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A system comprising:
a host processor; and
a target processor coupled to the host processor;
wherein the host processor is configured to:
receive a pre-compiled library, wherein the pre-compiled library is compiled from source code into a first intermediate representation prior to being received by the host processor;
compile the pre-compiled library from the first intermediate representation into a binary, wherein the binary comprises one or more kernels executable by the target processor; and
store the binary in a memory;
wherein responsive to detecting a request for a given kernel of the binary, the kernel is provided for execution by the target processor.

2. The system of claim 1, wherein provision of the kernel for execution by the target processor comprises either the target processor retrieving the kernel from a storage location or the host processor conveying the kernel to the target processor.

3. The system as recited in claim 1, wherein the host processor operates an open computing language (OpenCL) runtime environment, wherein opening the binary comprises loading a master index table corresponding to the binary into a memory of the host processor, and wherein retrieving the given kernel from the binary comprises looking up the given kernel in the master index table to determine a location of the given kernel within the binary.

4. The system as recited in claim 1, wherein the host processor is a central processing unit (CPU), the target processor is a graphics processing unit (GPU), and wherein the GPU comprises a plurality of processing elements.

5. The system as recited in claim 1, wherein the source code is written in open computing language (OpenCL).

6. The system as recited in claim 1, wherein compiling the pre-compiled library from a first intermediate representation into a binary comprises compiling the first intermediate representation into a second intermediate representation and then compiling the second intermediate representation into the binary.

7. The system as recited in claim 1, wherein the first intermediate representation of the pre-compiled library is encrypted, and wherein the host processor is configured to decrypt the first intermediate representation prior to compiling the first intermediate representation into a binary.

8. The system as recited in claim 1, wherein the first intermediate representation is a low level virtual machine (LLVM) intermediate representation.

9. A method comprising:
compiling an intermediate representation of a library into a binary, wherein the binary is targeted to a specific target processor;
retrieving a kernel from the binary responsive to detecting a request for the kernel; and
executing the kernel on the specific target processor.

10. The method as recited in claim 9, wherein retrieving a kernel from the binary comprises:
loading a master index table corresponding to the binary into a memory of the CPU; and
retrieving location information for the kernel from the master index table.

11. The method as recited in claim 9, wherein the specific target processor is a graphics processing unit (GPU).

12. The method as recited in claim 9, wherein the library comprises a plurality of kernels.

13. The method as recited in claim 9, wherein the library comprises source code written in an open computing language (OpenCL).

14. The method as recited in claim 9, wherein the IR comprises a low-level virtual machine (LLVM) IR, and wherein the method comprises compiling the LLVM IR into an intermediate language (IL) representation and compiling the IL representation into the binary.

15. The method as recited in claim 9, wherein the IR is compiled into a binary prior to detecting a request for the kernel.

16. The method as recited in claim 9, wherein the IR is not executable by the target processor.

17. A non-transitory computer readable storage medium comprising program instructions, wherein when executed the program instructions are operable to:
receive a pre-compiled library, wherein the pre-compiled library has been compiled from source code into a first intermediate representation prior to being received;
compile the pre-compiled library from the first intermediate representation into a binary, wherein the binary comprises one or more kernels directly executable by a target processor;
store the binary in a memory;
responsive to detecting a request for a given kernel of the binary: open the binary and retrieve the given kernel from the binary; and provide the given kernel to the target processor for execution.

18. The non-transitory computer readable storage medium as recited in claim 17, wherein the target processor is a graphics processing unit (GPU).

19. The non-transitory computer readable storage medium as recited in claim 17, wherein the source code is written in open computing language (OpenCL).

20. The non-transitory computer readable storage medium as recited in claim 17, wherein the first intermediate representation is compiled into a binary prior to detecting a request for a given kernel of the binary.

21. The non-transitory computer readable storage medium as recited in claim 17, wherein compiling the pre-compiled library from a first intermediate representation into a binary comprises compiling the first intermediate representation into a second intermediate representation and then compiling the second intermediate representation into the binary.

22. The non-transitory computer readable storage medium as recited in claim 17, wherein the first intermediate representation is a low level virtual machine (LLVM) intermediate representation.
